(19) United States
(12) Patent Application Publication
(10) Pub. No.: US 2008/0171159 A1
(43) Pub. Date: Jul. 17, 2008

(54) METHOD FOR STORING A DRUG-LOADED SUPPORT

(76) Inventor: Keisuke WATANABE, Ashiya (JP)

Correspondence Address: BIRCH STEWART KOLASCH & BIRCH, PO BOX 747, FALLS CHURCH, VA, 22040-0747, US

(21) Appl. No.: 11/971,810

(22) Filed: Jan. 9, 2008

(30) Foreign Application Priority Data
Jan. 17, 2007 (JP) 2007-007773

(51) Int. Cl. B65B 33/00; B32B 1/00

(52) U.S. Cl. 428/34.1; 427/155

(57) ABSTRACT

A method for storing a drug-loaded support, including a pyrethroid compound volatile at ambient temperature as an active ingredient and a carrier loaded therewith, which includes the step of sealing the drug-loaded support with a polylactic acid film. This method of storage reduces loss of active ingredient during the storage, and the drug-loaded support can show stable pest control effect even after long storage.

### BACKGROUND OF THE INVENTION

1. Field of the Invention

The present invention relates to a method for storing a drug-loaded support.

2. Description of Related Art

Drug-loaded supports containing different kinds of active ingredients, such as organophosphate compounds, for controlling pests are conventionally known. Among them, drug-loaded supports containing active ingredients volatile at ambient temperature have been widely suggested for use in controlling pests, because of their characteristic properties, etc.

To be more specific, sheets for sustained release of volatile drugs have been suggested, where the sheets are made, for instance, by dissolving a resin, which can serve as an adhesive, in a volatile drug, applying the resultant solution onto a film impermeable to the volatile drug, and pasting, over the applied surface, a biodegradable resin such as polylactic acid or a film that is permeable to the volatile drug, such as a polyolefin resin film (see, for instance, U.S. Pat. No. 6,656,303).

However, with drug-loaded supports containing an active ingredient volatile at ambient temperature, there is concern that the active ingredient may not show the full effect due to the loss and other defects caused during the storage between the production of the drug-loaded support and its use as well as the distribution, depending upon the properties of the drug-loaded support. For this reason, there is a demand for a superior method for storing a drug-loaded support.

On the other hand, ester compounds such as those represented by formula (I) are known as pyrethroid compounds volatile at ambient temperature (see, for instance, U.S. Pat. Nos. 6,225,495 and 6,294,576)

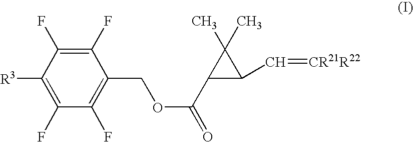

wherein, R²¹ and R²² are independently a hydrogen atom, a methyl group or a chlorine atom, and R³ is a hydrogen atom, a methyl group or a methoxymethyl group.

The problem underlying the present invention is to provide a method for storing a drug-loaded support including a pyrethroid compound volatile at ambient temperature and a carrier loaded therewith.

### SUMMARY OF THE INVENTION

After investigations aimed at finding a method for storing a drug-loaded support which contains a pyrethroid compound volatile at ambient temperature and a carrier loaded therewith, the present inventors discovered that if such a drug-loaded support that includes a pyrethroid compound volatile at ambient temperature and the carrier is sealed with a polylactic acid film, the loss of the pyrethroid compound, which is the active ingredient, is reduced and the above-mentioned problem is solved. This led to the present invention.

In other words, the present invention is as summarized in the following points 1 to 8.

1. A method for storing a drug-loaded support comprising a pyrethroid compound volatile at ambient temperature and a carrier loaded therewith, comprising the step of sealing the drug-loaded support with a polylactic acid film.

2. The method as described in point 1, wherein the polylactic acid film has a thickness of 10 to 100 micrometers.

3. The method as described in point 1 or 2, wherein the polylactic acid film is a biaxially stretched polylactic acid film.

4. The method as described in any one of points 1 to 3, wherein the carrier is a synthetic polymer carrier.

5. The method as described in any one of points 1 to 3, wherein the carrier is a thermoplastic resin.

6. The method as described in any one of points 1 to 5, wherein the pyrethroid compound volatile at ambient temperature is an ester compound represented by formula (I)

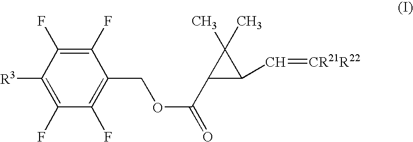

wherein R²¹ and R²² are independently a hydrogen atom, a methyl group or a chlorine atom, and R³ is a hydrogen atom, a methyl group or a methoxymethyl group.

7. The method as described in any one of points 1 to 7, wherein the pyrethroid compound volatile at ambient temperature is at least one compound selected from the group of 2,3,5,6-tetrafluoro-4-methoxymethylbenzyl 3-(1-propenyl)-2,2-dimethylcyclopropanecarboxylate, 2,3,5,6-tetrafluoro-4-methylbenzyl 3-(1-propenyl)-2,2-dimethylcyclopropanecarboxylate, 2,3,5,6-tetrafluoro-4-methoxymethylbenzyl 3-(2-methyl-1-propenyl)-2,2-dimethylcyclopropanecarboxylate, and 2,3,5,6-tetrafluorobenzyl 3-(2,2-dichlorovinyl)-2,2-dimethylcyclopropanecarboxylate.

8. A sealed drug-loaded support which comprises a drug-loaded support comprising a pyrethroid compound volatile at ambient temperature and a carrier loaded therewith, and a polylactic acid film that seals the drug-loaded support.

By adopting the method according to the present invention, the loss of pyrethroid compound volatile at ambient temperature during the storage of the drug-loaded support comprising a pyrethroid compound and a carrier loaded therewith can be reduced, and the drug-loaded support can show a stable pest control effect even after a long storage.

### DETAILED DESCRIPTION OF THE INVENTION

In the method according to the present invention, the drug-loaded support, which contains a pyrethroid compound volatile at ambient temperature and a carrier loaded therewith, is sealed with a polylactic acid film.

The pyrethroid compound volatile at ambient temperature used in the present invention (hereinafter referred to as “the present active ingredient”) is a pyrethroid compound with a vapor pressure of about 6×10⁻⁶ to about 1×10⁻⁴ mm Hg at 25° C. when measured, for instance, by the method reported by Stephen F. Donovan (New method for estimating vapor pressure by use of gas chromatography, Journal of Chromatography A. 749(1996) 123-129, hereinafter referred to as “Donovan method”) and an ester compound represented by formula (I)

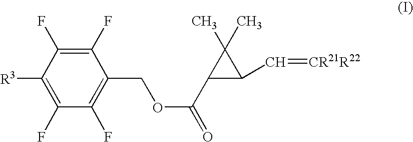

wherein R²¹ and R²² are independently a hydrogen atom, a methyl group or a chlorine atom, and R³ is a hydrogen atom, a methyl group or a methoxymethyl group.

Specific examples of the present active ingredient are 2,3,5,6-tetrafluoro-4-methylbenzyl 3-(1-propenyl)-2,2-dimethylcyclopropanecarboxylate (7.7×10⁻⁵ mm Hg), 2,3,5,6-tetrafluoro-4-methylbenzyl 3-(2-methyl-1-propenyl)-2,2-dimethylcyclopropanecarboxylate(3.1×10⁻⁵ mm Hg), 2,3,5,6-tetrafluorobenzyl 3-(2,2-dichlorovinyl)-2,2-dimethylcyclopropanecarboxylate (2.6×10⁻⁵ mm Hg), 2,3,5,6-tetrafluoro-4-methoxymethylbenzyl 3-(1-propenyl)-2,2-dimethylcyclopropanecarboxylate(1.4×10⁻⁵ mm Hg), and 2,3,5,6-tetrafluoro-4-methoxymethylbenzyl 3-(2-methyl-1-propenyl)-2,2-dimethylcyclopropanecarboxylate(6.8×10⁻⁶ mm Hg).

These active ingredients are compounds described, for instance, in the specifications of EP 0 060 617 A, and U.S. Pat. Nos. 6,225,495 and 6,294,576, and can be prepared by the methods described in these published documents. Moreover, these active ingredients can have isomers attributable to the asymmetric carbon atom(s) and isomers attributable to the carbon-carbon double bond(s), etc., and any active isomer can be used in the present invention.

The present invention uses a drug-loaded support containing the present active ingredient and a carrier loaded with the active ingredient. A solid carrier that can hold an effective amount of the present active ingredient for controlling pests, and moreover, can permit suitable vaporization of the present active ingredient at a temperature around the room temperature, is used as the carrier.

Examples of such a solid carrier include fibrous carriers like paper, woven fabrics, nonwoven fabrics, pulp, linter, and wood; porous carriers like ceramic sheets, and unglazed pottery sheets; synthetic polymer carriers such as thermoplastic resins (polyolefins such as polyethylene and polypropylene, and olefinic copolymers such as ethylene-methyl acrylate copolymer, ethylene-ethyl acrylate copolymer, ethylene-butyl acrylate copolymer, ethylene-methyl methacrylate copolymer, ethylene-ethyl methacrylate copolymer, propylene-methyl acrylate copolymer, propylene-ethyl acrylate copolymer, propylene-butyl acrylate copolymer, propylene-methyl methacrylate copolymer, and propylene-ethyl methacrylate copolymer); thermoplastic elastomers (styrene-based thermoplastic elastomers such as diblock copolymers such as hydrogenated styrene-butadiene block copolymer and hydrogenated styrene-isoprene block copolymer; and triblock copolymers such as hydrogenated styrene-butadiene-styrene block copolymer and hydrogenated styrene-isoprene-styrene block copolymer); etc.

There is no restriction on the shape of the carrier, which can be chosen to suit the mode of application. However, usually it is a sheet or mat of thickness about 0.01 to about 0.5 cm, with a flat surface of about 1×2 cm to about 60×60 cm, or those with voids (mesh, lattice, etc) made by processing, such as molding, sewing, and punching.

The drug-loaded support used in the present invention is a composition containing an active ingredient and a carrier loaded therewith. For holding the present active ingredient on the carrier, for instance, the carrier may be impregnated with the active ingredient if the carrier is a fibrous or porous material, or the active ingredient can be pre-mixed and kneaded with the carrier material and subjected to a appropriate processing, if the carrier is a synthetic polymer, according to the method described in U.S. Patent Publication No. 2006/0052444, for instance.

The amount of the present active ingredient loaded in the drug-loaded support usually ranges from 3 to 300 mg, preferably about 10 to about 200 mg, per cm³ of the drug-loaded support.

The drug-loaded support used in the present invention can also contain, in addition to the present active ingredient, pest control components, synergists, antioxidants, UV absorbers, antibacterial and antifungal agents, vaporization-controlling agents, dyes, fragrances, etc.

Examples of synergists include 5-[2-(2-butoxyethoxy)ethoxymethyl]-6-propyl-1,3-benzodioxol, N-(2-ethylhexyl)bicyclo[2.2.1]hept-5-en-2,3-dicarboximide, octachlorodipropyl ether, isobornyl thiocyanoacetate, and N-(2-ethhylhexyl)-1-isopropyl-4-methylbicyclo[2.2.2]octo-5-en-2,3-dicarboxyimide.

Examples of antioxidants include 2,6-di-t-butyl-4-methylphenol (BHT), butyl hydroxyanisole (BHA), stearyl β-(3,5-di-t-butyl-4-hydroxyphenyl)propionate, 4,4′-thiobis(3-methyl-6-t-butylphenol) (TBMTBP), and triphenyl phosphite.

Examples of antibacterial and antifungal agents include thymol, PCMX and OPP.

Examples of UV absorbers include phenyl salicylate; benzophenone compounds such as 2,4-dihydroxybenzophenone, 2-hydroxy-4-methoxybenzophenone, and 2-hydroxy-4-n-octyl-benzophenone; benzotriazole compounds such as 2-(2-hydroxy-5-methylphenyl)benzotriazole, 2-[2-hydroxy-3-(3,4,5,6-tetrahydrophthalimide-methyl)-5-methylphenyl]benzotriazole, 2-(3-tert-butyl-2-hydroxy-5-methylphenyl)-5-chlorobenzotriazole, 2-(2-hydroxy-5-tert-octylphenyl)benzotriazole, and 2-(2-hydroxy-3,5-di-tert-pentylphenyl)benzotriazole; and benzoate compounds such as 2,4-di-tert-butylphenyl-3,5-di-tert-butyl-4-hydroxybenzoate.

There are no specific restrictions as to the type of polylactic acid film used in the present invention so long as the polylactic acid film constitutes the entire innermost layer when the drug-loaded support used in the present invention is sealed with the film to prepare a sealed drug-loaded support. For instance, it can be a single layer polylactic acid film or a laminated polylactic acid film where the polylactic acid forms one of the outer layers and some other material forms another outer layer.

It is preferable that the sealing material is biodegradable, considering the environmental load after the use of such materials, and other factors. More specifically, a single layer film of polylactic acid is preferable.

Such a single layer polylactic acid film can be prepared from polylactic acid pellets (for example, LACIA (registered trademark, manufactured by Mitsui Chemicals Co. Ltd.)), etc through an ordinary method of film forming used for thermoplastic resins, such as the inflation method, T-die method, calendar method, and the like. It is preferable that such polylactic acid single layer film is a film that has been uniaxially or biaxially stretched by the method of roll stretching, tentor stretching, tube stretching, etc.

A commercially available polylactic acid single layer film can be used as such in the present invention. More specifically, Palgreen LC (registered trademark, biaxially stretched single layer polylactic acid film, manufactured by Tohcello Co. Ltd.), Ecoloju SB (registered trademark, stretched polylactic acid film, manufactured by Mitsubishi Plastics Inc.), Terramac TF (registered trademark, biaxially stretched polylactic acid film, manufactured by Unitika Ltd.), etc can be listed as examples.

Laminates of the aforesaid types of polylactic acid layers with layer(s) of other material(s) can be prepared by extrusion lamination, thermal lamination, dry lamination, and the like.

The polylactic acid film may be given surface treatments such as corona discharge treatment, flame treatment, plasma treatment, ozone treatment, etc.

The polylactic acid film prepared in the aforementioned manner usually has a thickness of 5 to 100 μm, preferably about 10 to about 100 μm, if it is a single layer film, and if it is a laminate of the polylactic acid layer with other layer(s), the thickness of the polylactic acid layer, which is the surface layer on one side of the laminate, is 5 to 80 μm, preferably about 10 to about 50 μm.

In the present invention, after preparing the drug-loaded support containing the present active ingredient and a carrier loaded therewith, the composition is sealed with a polylactic acid film to prepare a sealed drug-loaded support. This sealing suppresses the loss of the present active ingredient because of its adsorption to the packing materials, its release to the outside through the packaging material, etc, during the storage of the drug-loaded support. Typical methods of sealing include a method in which a drug-loaded support containing the present active ingredient is placed in a bag at least the innermost layer of which is the polylactic acid layer and sealing the opening (for example, by heat sealing or bonding with a synthetic resin adhesive), and a method of sandwiching a drug-loaded support containing the present active ingredient from both sides with two sheets of film having a polylactic acid layer at least on the surface that comes into contact with the composition and sealing the entire periphery (for example, by heat sealing or bonding with a synthetic resin adhesive).

The sealed drug-loaded support is unsealed, and the polylactic acid film removed to take out the drug-loaded support, at the time of using the drug-loaded support for pest control.

The drug-loaded support to be sealed with a polylactic acid film may be placed, if necessary, in an air-ventilable retaining frame, a drug-permeable casing, etc, and the entirety is sealed along with the casing.

### EXAMPLES

The present invention is described below in more detail citing a preparation example, test example, etc. However, the scope of the present invention is not limited to these examples.

Firstly, we shall describe an example of preparing a sealed drug-loaded support according to the present invention. Preparation example

28 parts by weight of ethylene-methyl methacrylate copolymer (proportion of methyl methacrylate in the copolymer: 25% by weight, trade name: ACRYFT WK 307, manufactured by Sumitomo Chemical Co. Ltd) and 5 parts by weight of 2,3,5,6-tetrafluoro-4-methoxymethylbenzyl 1R-trans-3-(1-propenyl (E/Z=1/8))-2,2-dimethylcyclopropanecarboxylate were melted and kneaded together in a closed pressure kneader (manufactured by Moriyama Manufacturing Co. Ltd.) and the kneaded material was hot-cut while being extruded from an extruder, to prepare pellets.

33 parts by weight of these pellets and 67 parts by weight of linear low density polyethylene (ethylene homopolymer) pellets were mixed and kneaded to obtain a kneaded material.

The kneaded material was then extruded in an extrusion molding machine through a special die for extruding nets, to prepare approximately 5 cm diameter cylindrical moldings, of a roughly diamond-shaped netting with one side of each diamond-shaped hole about 3.0 mm (the diameter of the filaments that formed the net was about 0.5 mm and net open area ratio was 70%). This molding was cut into lengths of about 15 cm to obtain the drug-loaded support.

Each drug-loaded support prepared in the aforesaid process was placed in a three side seal bag (16×23 cm) made of polylactic acid film (Palgreen (registered trademark) LC, biaxially stretched polylactic acid film, thickness 20 μm, manufactured by Tohcello Co. Ltd.) and the opening was heat-sealed to obtain a sealed drug-loaded support (hereinafter referred to as “the present sealed drug-loaded support”).

We shall next describe a reference production example of a sealed drug-loaded support.

### Reference Production Example

The drug-loaded support prepared in the production example was placed in a laminated film bag (19×25 cm, inner layer: unstretched polypropylene) prepared by laminating the unstretched polypropylene layer (thickness: 30 μm, trade name: PYLENE (registered trademark)—CT P1128, Toyo Boseki Co. Ltd.) with an aluminum layer, using an aliphatic ester adhesive. The opening was heat-sealed to obtain a sealed drug-loaded support for comparison (hereinafter referred to as “comparison sealed drug-loaded support”).

Next we shall describe the effectiveness of the present invention in a test example.

### Test Example

After storing the present sealed drug-loaded support at 60° C. for 1 month, the bag was unsealed, and the drug-loaded support was taken out and hung vertically from the ceiling of a test chamber of about 0.34 m³ (floor surface: 0.7×0.7 m, height: 0.7 m). Simultaneous with the hanging of the drug-loaded support in the chamber, 20 adult females of the common house mosquito (Culex pipiens pallens) were released into the chamber. 20 minutes later, the number of adult female mosquitoes knocked down were counted.

A similar test was also done using the comparison sealed drug-loaded support in place of the present sealed drug-loaded support. The results are given in Table 1.

TABLE 1

| | Number of mosquitoes |
|---|---|
| | knocked down |
| The present sealed drug- | 20 |
| loaded support | |
| Comparison sealed drug- | 2 |
| loaded support | |

1. A method for storing a drug-loaded support comprising a pyrethroid compound volatile at ambient temperature and a carrier loaded therewith, comprising the step of sealing the drug-loaded support with a polylactic acid film.

2. The method according to claim 1, wherein the polylactic acid film has a thickness of 10 to 100 micrometers.

3. The method according to claim 1, wherein the polylactic acid film is a biaxially stretched polylactic acid film.

4. The method according to claim 1, wherein the carrier is a synthetic polymer carrier.

5. The method according to claim 4, wherein the carrier is a thermoplastic resin.

6. The method according to claim 1, wherein the pyrethroid compound volatile at ambient temperature is an ester compound represented by formula (I) 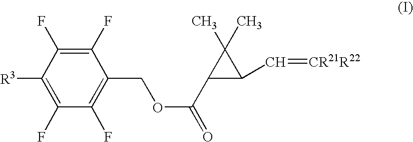
wherein R²¹ and R²² are independently a hydrogen atom, a methyl group or a chlorine atom, and R³ is a hydrogen atom, a methyl group or a methoxymethyl group.

7. The method according to claim 1, wherein the pyrethroid compound volatile at ambient temperature is at least one compound selected from the group consisting of 2,3,5,6-tetrafluoro-4-methoxymethylbenzyl 3-(1-propenyl)-2,2-dimethylcyclopropanecarboxylate, 2,3,5,6-tetrafluoro-4-methylbenzyl3-(1-propenyl)-2,2-dimethylcyclopropanecarboxylate, 2,3,5,6-tetrafluoro-4-methoxymethylbenzyl 3-(2-methyl-1-propenyl)-2,2-dimethylcyclopropanecarboxylate, and 2,3,5,6-tetrafluorobenzyl 3-(2,2-dichlorovinyl)-2,2-dimethylcyclopropanecarboxylate.

8. A sealed drug-loaded support which comprises a drug-loaded support comprising a pyrethroid compound volatile at ambient temperature and a carrier loaded therewith, and a polylactic acid film that seals the drug-loaded support.
